(19) United States
(12) Patent Application Publication
(10) Pub. No.: US 2011/0268575 A1
(43) Pub. Date: Nov. 3, 2011

(54) SPOKE FOR A STATOR COMPONENT, STATOR COMPONENT AND METHOD FOR MANUFACTURING A STATOR COMPONENT

(75) Inventors: Joachim Steffenburg-Nordenström, Vastra Tunhem (SE); Henrik Gustavsson, Trollhattan (SE)

(73) Assignee: VOLVO AERO CORPORATION

(21) Appl. No.: 13/139,900

(22) PCT Filed: Dec. 19, 2008
(86) PCT No.: PCT/SE08/00737

§ 371 Date: Jul. 19, 2011

(51) Int. Cl. F01D 5/22; B23P 15/02

(52) U.S. Cl. 416/191; 29/889.7

(57) ABSTRACT

A spoke for a stator component for conducting a gas flow during operation includes at least two wall parts connecting a leading edge and a trailing edge of the spoke, and a middle portion between a first and a second end portion along a longitudinal extension. A first imaginary extension line from a first segment of the first wall part to a second segment of the second wall part and a second imaginary extension line from a second segment of the first wall part to a first segment of the second wall part are intersecting within the wall parts in the middle portion.

### BACKGROUND AND SUMMARY

The present invention relates to a stator component and a method for manufacturing a stator component which is intended during operation to conduct a gas.

Jet engines are known in the art. Jet engine is meant to include various types of engines which admit air at relatively low velocity, heat it by combustion and shoot it out at a much higher velocity. Accommodated within the term jet engine are, for example, turbojet engines and turbo-fan engines.

A component of this kind, comprising an outer and an inner ring with wall parts arranged between the rings can be arranged with a view to primarily being force-transmitting in the radial and axial direction. The wall parts can, for example, form hollow blades, which are usually shaped such that they offer as little air resistance as possible. The component can, for instance, be arranged in a rear or front stand, or in an intermediate housing in a jet engine. The blades are often referred to in such a case as stays or struts.

Struts can, however, also be formed by other types of parts than hollow blades.

According to the prior art, wall parts in the form of hollow blades are arranged at a distance apart in the circumferential direction of the component between an inner and an outer ring. The hollow blades are joined together with the rings by welding. Each of the rings is made in this case firstly with portions of the same cross-dimensional shape and size as the blades, protruding in the radial direction. Such protruding portions are often referred to as stubs. Each of the blades is then welded to a protruding portion of this kind by means of a butt joint. The radially protruding portions are usually mill-cut from a ring. This is a time-consuming and costly operation.

In WO 2004/016910 A1 a stator component is disclosed which has a box-like structure. The stator component is made up of at least two sections in its circumferential direction. Each of the sections has at least one wall part and are placed adjacent to each other so that two wall parts, one from each of two adjacent sections, are connected in order together to form a spoke which extends in the radial direction of the stator component, for guidance of said gas flow and/or transmission of load during operation of the component. The gas-flow-guidance or load-transmission spokes are thus made up of two separate wall parts, one from each section. This spoke will thus delimit adjoining gas ducts in the circumferential direction. The gas ducts thus extend in the axial direction of the component.

It is desirable to provide a spoke for a stator component which can carry loads with long working life. It is also desirable to provide an improved stator component which avoids expensive castings in manufacturing of the stator component. It is also desirable to provide an improved method for manufacturing a stator component.

A spoke for a stator component for conducting a gas flow during operation is proposed, comprising at least two wall parts connecting a leading edge and a trailing edge of the spoke, and comprising a middle portion between a first and a second end portion along a longitudinal extension. Between the leading and the trailing edges a first imaginary extension from a first segment of the first wall part towards a second segment of the second wall part and a second imaginary extension from a second segment of the first wall part towards a first segment of the second wall part are intersecting within the wall parts in the middle portion.

Particularly, the extension continues in the same direction as the segment. If the segment has a curvature, the extension continues with the curvature. Particularly, if the segment is linear, the extension continues linearly.

In a very symmetric case, the imaginary extension projecting from the first segment of the first wall part towards the second segment of the second wall part and the imaginary extension projecting from the second segment of the first wall part towards a first segment of the second wall part intersect at the same point between the wall parts as an imaginary extension from a first segment of the second wall part towards a second segment of the first wall part and an imaginary extension from a second segment of the second wall part towards a first segment of the first wall part. The extension lines and the segments form an X-shape.

However, there can be two intersections between the wall parts with a first intersection between the imaginary extension projecting from the first segment of the first wall part and the imaginary extension projecting from second segment of the first wall part and a second intersection between the imaginary extension projecting from the second segment of the second wall part and the imaginary extension projecting from the first segment of the second wall part.

In this way, a so called spoke frame can be formed with load carrying spokes. The spokes can either be casted or fabricated by composing multiple members together forming a spoke. Today, the spoke frames are manufactured as complete castings. Favourably, according to the invention, it is possible to avoid big expensive castings, as the geometry provides a better weld access.

The intersection of the imaginary extensions of the end portions within the middle section between the wall parts is very advantageous with respect to stiffness.

The stiffness of the spoke can be further increased according to a favourable embodiment, if the first and second imaginary extensions can form an X-shaped intersection in the middle portion. The X-shaped intersection is more favourable as load carrier with respect to stiffness. Favourably, the X-shape's angle can be an optimum of a number of spokes and a height between a so called mid case and a hub. The X-shape gives also a good access to welds for inspection, both at the top and root side of the spokes. Particularly, in this symmetric case the first segment of the first wall part and the second segment of the second wall part are lying on a first common imaginary extension line and the second segment of the first wall part and the first segment of the second wall part are lying on a second common imaginary extension line.

According to a further favourable embodiment of the invention, the first and the second segments of the first and the second end portions can exhibit a planar shaped cross section between the leading and the trailing edge. Favourably, the end portions exhibit an X-shape with the intersection of imaginary extensions in the centre region of the X-shape.

According to a further favourable embodiment of the invention, at least one web can be provided at the wall parts for attaching one or more duct sheets. The web can be arranged to give a good weld access to the outer surface of the wall parts of the spoke.

According to a further favourable embodiment of the invention, a first and a second web can be provided spaced apart in longitudinal direction for attaching one or more sheets. Thus, attachment means for attaching duct sheets or the like can be provided about the spoke.

According to a further favourable embodiment of the invention, a web can be provided at a free end of the wall parts for connecting one or more duct sheets. The web can cover the free end of the spoke, yielding a part of a mid case.

According to a further favourable embodiment of the invention, a stub can provided at a free end of the wall parts for attaching the wall parts to a hub. The stub can be preferably provided at the root of the spoke.

According to a further aspect of the invention, a stator component for conducting a gas flow during operation is proposed, comprising at least two spokes in its circumferential direction extending in the stator component's radial direction, which spokes each have at least two wall parts for guidance of said gas flow and/or transmission of load during operation. At least one spoke comprises (a) at least two wall parts which connect a leading edge and a trailing edge of the spoke and (b) a middle portion between a first and a second end portion along a longitudinal extension, wherein at least in an inner region of the wall parts between the leading and the trailing edges a first imaginary extension from a first segment of the first end portion to a second segment of the second end portion and a second imaginary extension from a second segment of the first end portion to a first segment of the second end portion are intersecting within the wall parts in the middle portion.

According to a favourable embodiment of the invention, all spokes can comprise a middle portion between a first and a second end portion along a longitudinal extension, wherein a first imaginary extension from a first segment of the first end portion to a second segment of the second end portion and a second imaginary extension from a second segment of the first end portion to a first segment of the second end portion are intersecting within the wall parts in the middle portion. Favourably, an easy-to-manufacture spoke frame can be provided for a stator component. The stator component can preferably be used, for example, in a gas turbine and especially in a jet engine. Advantageously, such a stator component can be used as a base model for a plurality of kinds of stator component structures.

According to a further favourable embodiment of the invention, the first and the second segments of the first and the second end portions can exhibit a planar shaped cross section between the leading and the trailing edge. Favourably, the end portions exhibit an X-shape with the intersection of imaginary extensions in the centre region of the X-shape.

According to a further favourable embodiment of the invention, an angle of the intersection can be selected according to a number of spokes in circumferential direction and longitudinal extension of the spokes between a mid case and a hub.

According to a further aspect of the invention, a method for fabricating a stator component is proposed, comprising the steps of providing one or more spokes; attaching the one or more spokes to a hub; attaching one or more first sheets to a first web of the one or more spokes; attaching one or more second sheets to a second web of the one or more spokes; attaching one or more third sheets to a third web of the one or more spokes.

A further favourable step of the invention can comprise casting the one or more spokes. As the spoke is a relatively simple geometry despite its favourable mechanical and dynamical properties, the casting can be performed in a less complex way than casting of a complete spoke frame.

A further favourable step of the invention can comprise composing the one or more spokes from a multitude of members. The preferred geometry of the spokes allows a good access to weld seams for manufacturing and inspection.

A further favourable step of the invention can comprise connecting the spokes by welding the first sheets to the first webs of the one or more spokes. The preferred geometry of the spokes allows a good access to weld seams for manufacturing and inspection.

A further favourable step of the invention can comprise connecting the spokes by welding the second sheets to the second webs of the one or more spokes thus forming a duct channel between the middle portions of the spokes and the first and second sheets. The preferred geometry of the spokes allows a good access to weld seams for manufacturing and inspection.

A further favourable step of the invention can comprise connecting the spokes by welding the third sheets to the third webs of the one or more spokes thus forming a mid case between the end portions of the spokes.

### BRIEF DESCRIPTION OF THE DRAWINGS

The present invention together with the above-mentioned and other objects and advantages may best be understood from the following detailed description of the embodiments, but not restricted to the embodiments, wherein is shown schematically:

FIG. 1a, 1b a preferred embodiment of a spoke according to the invention (FIG. 1a) and a cross section of the spoke along the cut 1b featuring a X-formed intersection in a middle portion of the spoke seen from the front face;

FIG. 2 a hub as a basis element of a preferred embodiment of a stator component according to the invention;

FIG. 3 spokes connected to the hub of FIG. 2);

FIG. 4a, 4b a first sheet (FIG. 4a), and first sheets forming a first duct surface connected to spokes (FIG. 4b) according to FIG. 3;

FIG. 5a, 5b a second sheet (FIG. 5a), and second sheets forming a second duct surface connected to spokes (FIG. 5b) according to FIG. 3; and

FIG. 6a, 6b a third sheet (FIG. 6a), and third sheets forming an outer mid case surface connected to spokes (FIG. 6b) according to FIG. 3.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

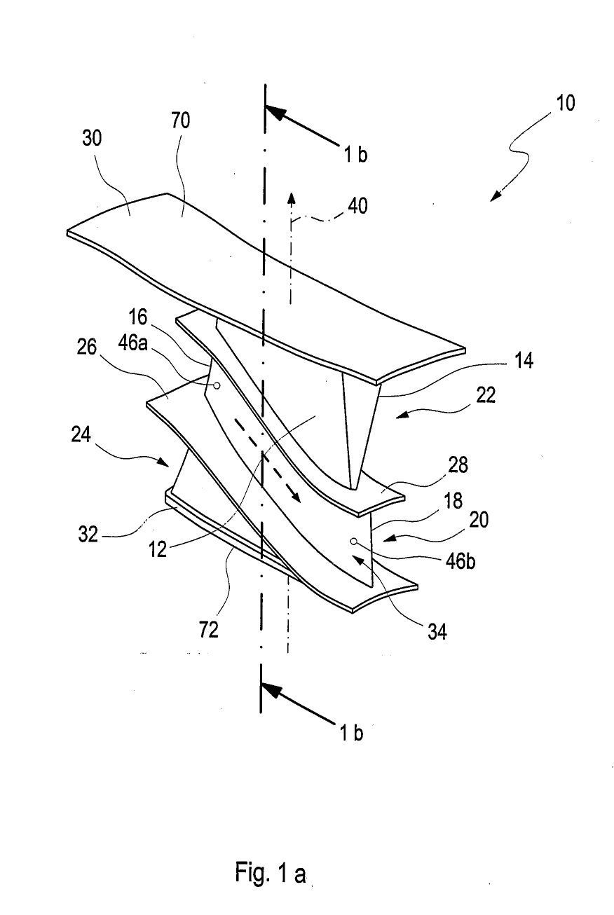

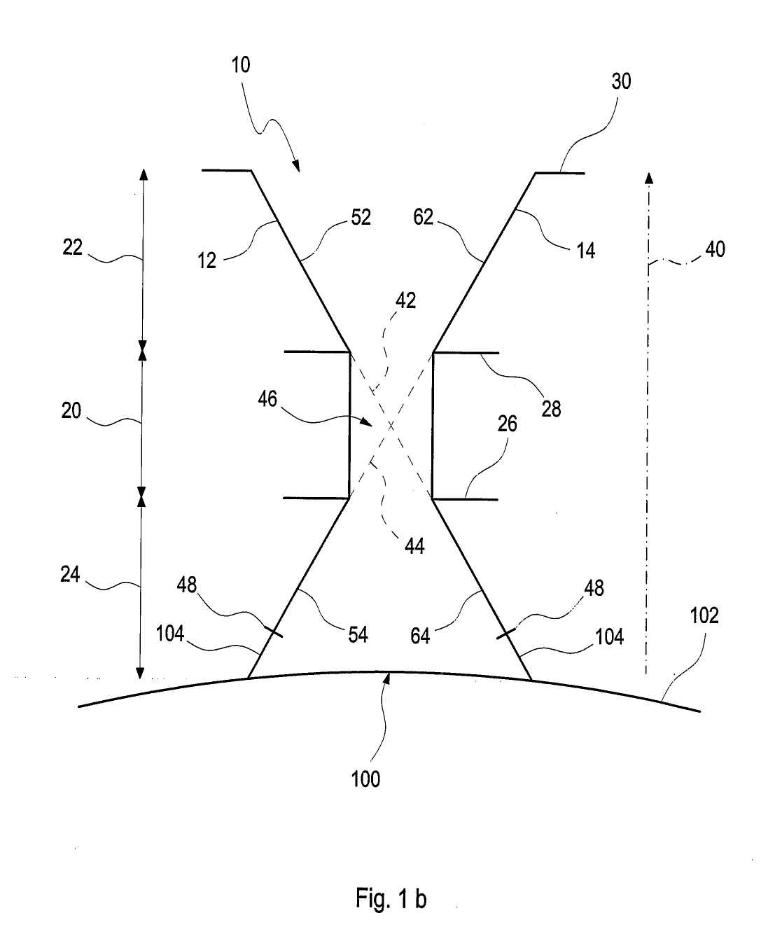

FIG. 1a depicts a perspective view of a preferred embodiment of a spoke 10 according to the invention, and FIG. 1b illustrates a cross sectional view on the cut along line 1b in FIG. 1a seen from the front face.

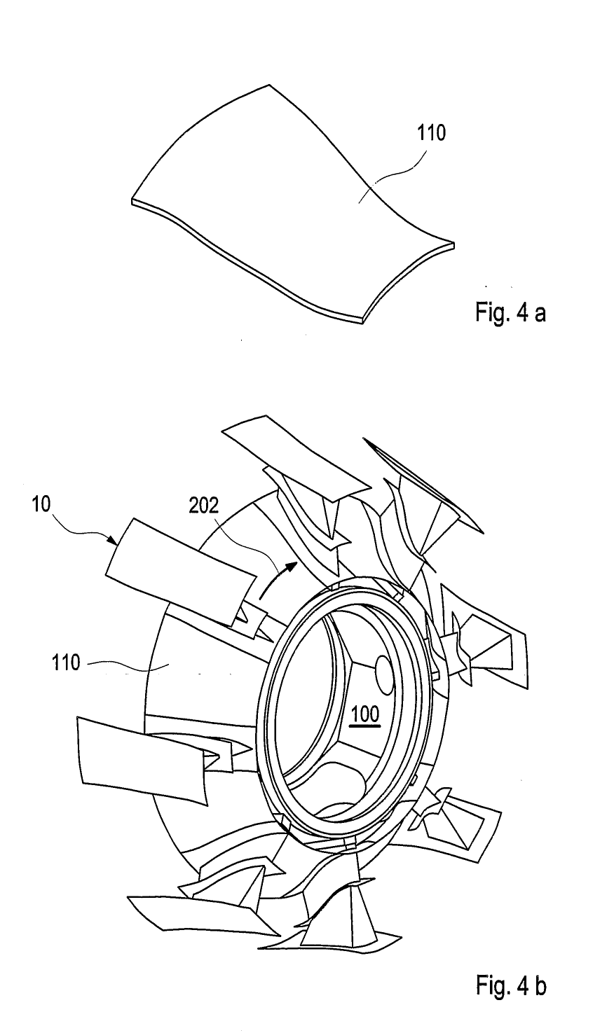

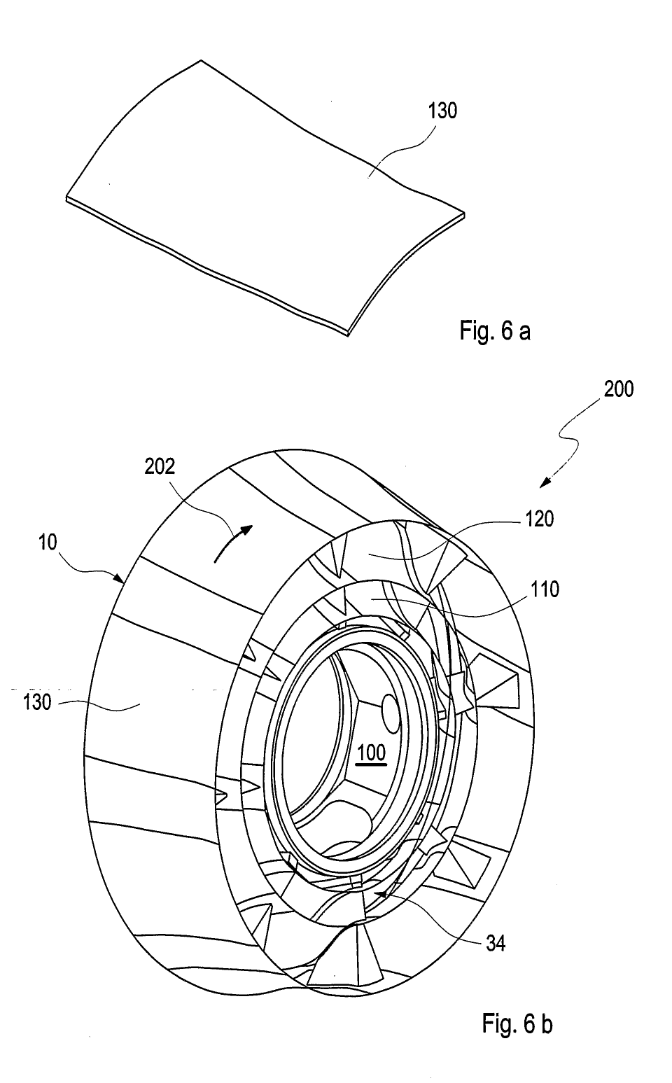

The spoke 10 is particularly intended for use in a stator component 200 (FIG. 6b) for conducting a gas flow during operation. The gas flow during operation is indicated by an arrow drawn with a broken line positioned in a middle portion 20 of the spoke 10. This middle portion 20 of the spoke 10 when integrated in a stator component (FIG. 6b) is also called a vane. The middle portion 20 is defined as the area between a first web 26 and a second web 28 which are provided spaced apart in longitudinal direction 40 for attaching one or more duct sheets 110, 120 as will be described later in FIGS. 4a-6b.

The spoke 20 comprises at least two wall parts 12, 14 connecting a leading edge 16 and a trailing edge 18 of the spoke 10. The middle portion 20 is arranged between a first and a second end portion 22, 24 of the spoke 10 along a longitudinal extension 40. The middle portion 20 can be closer to the free end 72 of the second end portion 24 at the trailing edge 18 and closer to the free end 70 of the first end portion 22 of the leading edge 16.

According to the invention, at least in an inner region of the wall parts 12, 14 between the leading and the trailing edges 16, 18 a first imaginary extension line 42 projecting from a first segment 52 in the first end portion 22 of the first wall part 12 to a second segment 64 in the second end portion 24 of the second wall part 14 and a second imaginary extension line 44 projecting from a second segment 62 in the first end portion 22 of the second wall part 14 to a first segment 54 in the second end portion 24 of the first wall part are intersecting between the wall parts 12, 14 in the middle portion 20. The wall part 12 consists of or comprises one side of the end portion 22, the middle portion 20 and the second end portion 24 (the left side in FIG. 1b). The wall part 14 consists of or comprises the opposite side of the first end portion 22, the middle portion 20 and the second end portion 24 (the right side in FIG. 1b). The first and second segments 52, 62 and 54, 64 are portions of the first and second end portions 22, 24 of the wall structures 12, 14 arranged close to the middle portion 20.

The imaginary extension lines 42, 44 are shown as broken lines intersecting in within the wall parts 12, 14 in the middle portion 20 of the spoke 10. As can be seen in FIG. 1b the first and second imaginary extension lines 42, 44 form an X-shaped intersection 46 in the middle portion 20. Preferably, the angle of the intersecting extension lines 42, 44 forming the “X” can be adapted to provide an optimum stiffness for a given number and height of a multitude of spokes 10 in a stator component 200 (FIG. 6b). At least the first segments 52, 54 and second segments 62, 64 which are arranged close to the middle portion 20 are linear in the longitudinal cut through the spoke 10. Preferably, the complete end portions 22, 24 are linear in the longitudinal cut through the spoke 10 as can be seen in FIG. 1b. This provides a favourable stiffness of the spoke 10.

The intersection 46, i.e. the centre of the X-shape, follows the flow path in the middle portion 20. Preferably, when moving along the flow path, the intersection 46 at each point along the flow path is located on a line e.g. in the geometrical middle between the lower and upper boundaries of the middle portion 20 formed by the first and second webs 26 and 28 or follow at least a straight line between the vertical centres of the leading and trailing the edges 16, 18. In FIG. 1a, dots 46a, 46b roughly indicate these vertical centres.

The first and the second segments 52, 62 and 54, 64 of the first and the second end portions 22, 24 exhibit a planar shaped cross section between the leading and the trailing edge 16, 18.

A web 30 is provided at a free end 70 of the wall parts 12, 14 for connecting One or more duct sheets 130 (FIG. 6a, 6b). Whereas the first and second webs 26; 28 are tilted in a relatively strong way with respect to the height of the webs 26, 28 on the longitudinal extension of the spoke 10, the third web 30 is virtually at the same height with respect to the longitudinal extension of the spoke 10.

A stub 32 is provided at a free end 72 forming a root portion of the wall parts 12, 14 for attaching the wall parts 12, 14 to another component, particularly to a hub 100. A web seam 48 is indicated which connects the spoke 10 to a stub structure same inclination.

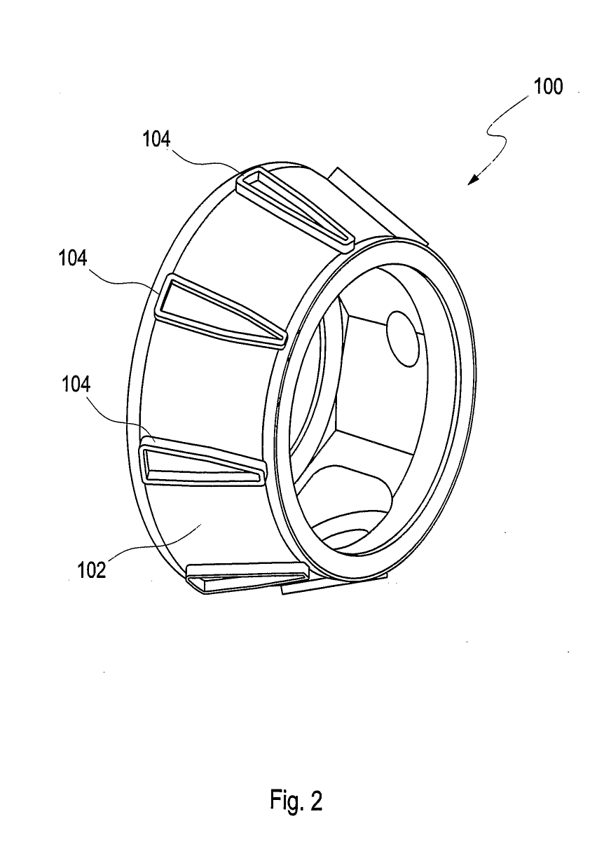

Referring now to FIGS. 2 to 6b, assembling of a preferred embodiment of a stator component 200 for conducting a gas flow during operation is depicted.

A basis element of the assembly is a conically shaped hub 100 shown in FIG. 2. On an outer surface 102 of the hub 100 stub structures 104 are provided which are arranged as interface for the root portions of the spokes 10. The stub structures 104 exhibit triangular cross sections which correspond to a triangular shape of the free ends 70 of the first end portions 22 of the spokes 10. Preferably, each of the spokes 10 is welded to a respective stub structure 104 on the hub 100, as already indicated in FIG. 2.

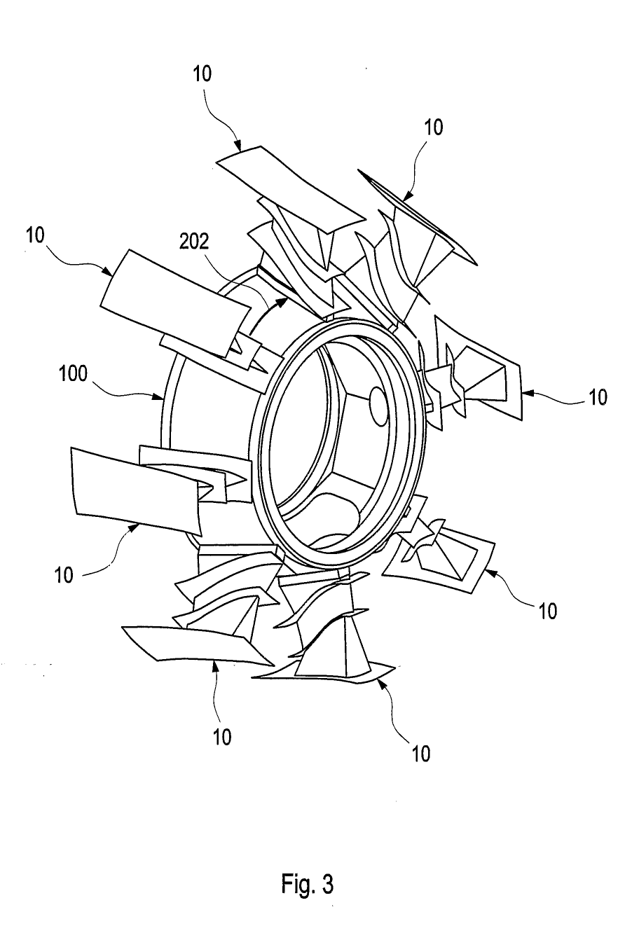

FIG. 3 depicts eight spokes 10 attached to the hub 100, equally distributed along a circumferential direction 202. The webs 26, 28 and 30 arranged about each of the spokes 10 in different heights of the longitudinal extension provide interfaces for attaching sheets which connect the spokes 10 in various radial heights of the structure.

FIG. 4a displays a first sheet 110 which forms an inner duct structure when each one first sheet 110 is inserted between two spokes 10 and preferably welded to the respective first 26 webs of the two spokes 10, as shown in FIG. 4b. The first sheets 110 exhibit a smooth curved surface designed to reveal desired flow properties of the stator component 200 (FIG. 6b) during operation.

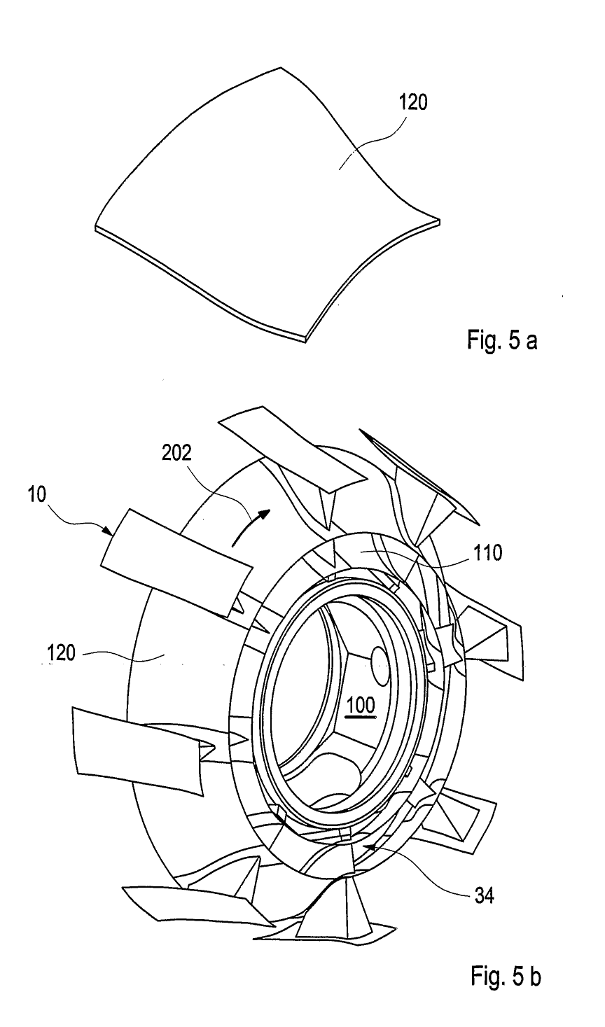

FIG. 5a displays a second sheet 120 which forms an outer duct structure when each one second sheet 120 is inserted between two spokes 10 and preferably welded to the respective second webs 28 of the two spokes 10, as shown in FIG. 5b. The second sheets 120 exhibit a smooth curved surface designed to reveal desired flow properties of the stator component 200 (FIG. 6b) during operation.

Between the inner and outer duct structures formed by the first and second sheets 112, 120 and the middle portions 20 of the spokes 10 air channels 34 are formed designed for guiding air during operation of the stator component 200 (FIG. 6b), with the middle region 20 providing the vane of the stator component 200 (FIG. 6b).

Finally, FIG. 6a displays a third sheet 130 which forms a mid case structure when each one third sheet 130 is inserted between two spokes 10 and preferably welded to the respective third webs 30 of the two spokes 10, as shown in FIG. 6b. The third sheets 130 exhibit a smooth more even surface compared to the first and second sheets 110, 120. Protruding from the outer surface of the mid case structure formed by the third sheets 130 connected by the third webs 30 of the spokes 10 are knob-like structures 74, so called target bosses, on each web 30 which are used in a usual way for manufacturing reasons to know where the geometry of the structure is situated.

A preferred method for manufacturing the stator component 200 comprises the steps of welding the spokes 10 to the hub 100, welding the inner first sheets 110 in between the spokes 10, welding the outer second sheets in between the spokes 10, and welding the outer mid case sheets 130 in between the spokes 30.

The stator component 200 forms a spoke frame which can be used as a base model structure which can be easily adapted for various types of mid case (IMC intermediate mid case) or compressor case (ICC intermediate compressor case) structures.

1. A spoke for a stator component for conducting a gas flow during operation, comprising at least two wall parts connecting a leading edge and a trailing edge of the spoke, and comprising a middle portion between a first and a second end portion along a longitudinal extension, wherein wherein between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion.

2. The spoke according to claim 1, wherein the first and second imaginary extension lines form an X-shaped intersection in the middle portion.

3. The spoke according to claim 1, wherein the first and the second segments of the first and the second end portions exhibit a planar shaped cross section between the leading and the trailing edge.

4. The spoke according to claim 1, wherein at least one web is provided at the wall parts for attaching one or more duct sheets.

5. The spoke according to claim 1, wherein a first and a second web is provided spaced apart in longitudinal direction for attaching one or more sheets.

6. The spoke according to claim 1, wherein a web is provided at a free end of the wall parts for connecting one or more duct sheets.

7. The spoke according to claim 1, wherein a stub is provided at a free end of the wall parts for attaching the wall parts to a hub.

8. A stator component for conducting a gas flow during operation, comprising at least two spokes in its circumferential direction extending in the stator component's radial direction, which spokes each have at least two wall parts for guidance of the gas flow and/or transmission of load during operation, wherein at least one spoke comprises
at least two wall parts which connect a leading edge and a trailing edge of the spoke, and
a middle portion between a first and a second end portion along a longitudinal extension, wherein at least in an inner region of the wall parts between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion.

9. The stator component according to claim 8, wherein all spokes comprise a middle portion between a first and a second end portion along a longitudinal extension, wherein a first imaginary extension line from a first segment of the first end portion to a second segment of the second end portion and a second imaginary extension line from a second segment of the first end portion to a first segment of the second end portion are intersecting within the wall parts in the middle portion.

10. The stator component according to claim 8, wherein the first and second imaginary extension lines form an X-shaped intersection in the middle portion.

11. The stator component according to claim 8 wherein an angle of the intersection is selected according to a number of spokes in circumferential direction and longitudinal extension of the spokes between a mid case and a hub.

12. A method for fabricating a stator component according to claim 8, comprising
providing one or more spokes for a stator component for conducting a gas flow during operation, each spoke comprising at least two wall parts connecting a leading edge and a trailing edge of the spoke, and comprising a middle portion between a first and a second end portion along a longitudinal extension, wherein between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion;
attaching the one or more spokes to a hub;
attaching one or more first sheets to a first web of the one or more spokes;
attaching one or more second sheets to a second web of the one or more spokes
attaching one or more third sheets to a third web of the one or more spokes.

13. The method according to claim 12, comprising casting the one or more spokes.

14. The method according to claim 12, comprising composing the one or more spokes from a multitude of members.

15. The method according to claim 12, comprising connecting the spokes by welding the first sheets to the first webs of the one or more spokes.

16. The method according to claim 12, comprising connecting the spokes by welding the second sheets to the second webs of the one or more spokes thus forming a duct channel between the middle portions of the spokes and the first and second sheets.

17. The method according to claim 12, comprising connecting the spokes by welding the third sheets to the third webs of the one or more spokes thus forming a mid case between the end portions of the spokes.

18. A spoke for a stator component for conducting a gas flow during operation, comprising at least two wall parts connecting a leading edge and a trailing edge of the spoke, and comprising a middle portion between a first and a second end portion along a longitudinal extension, wherein at least in an inner region of the wall parts between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion.

19. The spoke according to claim 18, wherein the first and second imaginary extension lines form an X-shaped intersection in the middle portion.

20. The spoke according to claim 18, wherein the first and the second segments of the first and the second end portions exhibit a planar shaped cross section between the leading and the trailing edge.

21. The spoke according to claim 18, wherein at least one web is provided at the wall parts for attaching one or more duct sheets.

22. The spoke according to claim 18, wherein a first and a second web is provided spaced apart in longitudinal direction for attaching one or more sheets.

23. The spoke according to claim 18, wherein a web is provided at a free end of the wall parts for connecting one or more duct sheets.

24. The spoke according to claim 18, wherein a stub is provided at a free end of the wall parts for attaching the wall parts to a hub.

25. A stator component for conducting a gas flow during operation, comprising at least two spokes in its circumferential direction extending in the stator component's radial direction, which spokes each have at least two wall parts for guidance of the gas flow and/or transmission of load during operation, wherein at least one spoke comprises
at least two wall parts which connect a leading edge and a trailing edge of the spoke, and
a middle portion between a first and a second end portion along a longitudinal extension, wherein at least in an inner region of the wall parts between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion.

26. The stator component according to claim 25, wherein all spokes comprise a middle portion between a first and a second end portion along a longitudinal extension, wherein a first imaginary extension line from a first segment of the first end portion to a second segment of the second end portion and a second imaginary extension line from a second segment of the first end portion to a first segment of the second end portion are intersecting within the wall parts in the middle portion.

27. The stator component according to claim 25, wherein the first and second imaginary extension lines form an X-shaped intersection in the middle portion.

28. The stator component according to claim 25, wherein an angle of the intersection is selected according to a number of spokes in circumferential direction and longitudinal extension of the spokes between a mid case and a hub.

29. A method for fabricating a stator component according to claim 25, comprising
providing one or more spokes for a stator component for conducting a gas flow during operation, each spoke comprising at least two wall parts connecting a leading edge and a trailing edge of the spoke, and comprising a middle portion between a first and a second end portion along a longitudinal extension, wherein at least in an inner region of the wall parts between the leading and the trailing edges a first imaginary extension line from a first segment of the first wall part to a second segment of the second wall part and a second imaginary extension line from a second segment of the first wall part to a first segment of the second wall part are intersecting within the wall parts in the middle portion;
attaching the one or more spokes to a hub;
attaching one or more first sheets to a first web of the one or more spokes;
attaching one or more second sheets to a second web of the one or more spokes;
attaching one or more third sheets to a third web of the one or more spokes.

30. The method according to claim 29, comprising casting the one or more spokes.

31. The method according to claim 29, comprising composing the one or more spokes from a multitude of members.

32. The method according to claim 29, comprising connecting the spokes by welding the first sheets to the first webs of the one or more spokes.

33. The method according to claim 29, comprising connecting the spokes by welding the second sheets to the second webs of the one or more spokes thus forming a duct channel between the middle portions of the spokes and the first and second sheets.

34. The method according to claim 29, comprising connecting the spokes 10 by welding the third sheets to the third webs of the one or more spokes thus forming a mid case between the end portions of the spokes.
